(19) United States
(12) Patent Application Publication
(10) Pub. No.: US 2004/0206819 A1
(43) Pub. Date: Oct. 21, 2004

(54) Code reader

(75) Inventors: Tohru Okada, Aichi-gun (JP); Toshiharu Kawashima, Nishikasugai-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN ENGINEERING CO., LTD., Kariya (JP)

(21) Appl. No.: 10/674,466

(22) Filed: Oct. 1, 2003

(30) Foreign Application Priority Data
Oct. 1, 2002 (JP) JP2002-324505

(51) Int. Cl. G06K 7/10; G06K 7/14

(52) U.S. Cl. 235/454

(57) ABSTRACT

A code reader includes: a housing including a reading portion for reading a code provided on a surface of an object; image capturing means provided in the housing for capturing an image of the code; light generating means including a light source provided in the housing for irradiating an illumination light to the code; light restriction means for restricting an amount of reflected illumination light, reflected after contacting the code, that enters the image capturing means; and a flexible board provided on the housing, on which the light source is positioned.

This application is based on and claims priority under 35 U.S.C. §119 with respect to Japanese Patent Application No. 2002-324505 filed on Oct. 1, 2002, the entire contents of which are incorporated herein by reference.

### BACKGROUND OF THE INVENTION

1. Field of the Invention

The present invention relates to a code reader. More particularly, the present invention pertains to an internal construction of a code reader for reading the unique information shown on a code (e.g., a one dimensional code, a two dimensional code, a three dimensional code, and a multi-dimensional code combining different codes) provided on an object.

2. Description of the Related Art

In order to control particular objects (e.g., products), individual products may be provided with a code (e.g., one dimensional code, a two dimensional code, a three dimensional code, and a multi-dimensional code for showing unique information related to each product, hereafter “the code”) printed on a surface, such as paper, for distinguishing each product. The code provided on the product is read by decoding the information shown on the code, thereby enabling control of the inventory of products, for example.

For example, the foregoing code reader includes a light entrance diaphragm mechanism provided in a housing, and a lens and a CCD camera provided on a back thereof. A pair of light sources are provided on a reading opening surface side facing the code for illuminating light from the light sources to the light entrance diaphragm mechanism to irradiate a surface to be read. In this case, an internal peripheral surface of the housing and the diaphragm mechanism surface may be a camouflaged color, such as a fluorescent color or a diffusive camouflaged color (such as white). The light from the light source is irradiated to the internal peripheral surface of the housing and the diaphragm mechanism surface of the light entrance diaphragm mechanism to irradiate the surface to be read provided with the code with the indirect illumination by the reflective light.

For example, the code reader with the foregoing construction is described in Japanese Patent Laid-Open Publication No. H10-111905. With the code reader described in Japanese Patent Laid-Open Publication No. H10-111905, the light source providing the illumination light is provided between the light entrance diaphragm mechanism and reading surface on a side portion of the housing.

In case the light source for generating the illumination light is provided between the light entrance diaphragm mechanism and reading surface, the light source is provided on a position away from a circuit board for recognizing the code. Thus, wiring to the light source for driving the illumination is involved. In addition, in case a pair of the light sources is provided in the housing, the question where the wiring should be provided through from the driver (drive circuit) to the light source is raised, which complicates the wiring construction. In this case, an increase of the number of the light sources in order to brightly illuminate the surface to be read further complicates the wiring construction.

A need thus exists for a code reader that achieves the wiring from the driver for driving the light source to the light source with a simple construction and performs the wiring from the driver for driving the plural light sources to the light source with a simple construction.

### SUMMARY OF THE INVENTION

In light of the foregoing, the present invention provides a code reader that includes a housing including a reading portion for reading a code provided on a surface of an object; image capturing means provided in the housing for capturing an image of the code; light generating means including a light source provided in the housing for irradiating an illumination light to the code; light restriction means for restricting an amount of reflective light of the illumination light, reflected after contacting the code, that enters the image capturing means; and a flexible board provided on the housing, on which the light source is positioned.

### BRIEF DESCRIPTION OF THE DRAWINGS

The foregoing and additional features and characteristics of the present invention will become more apparent from the following detailed description considered with reference to the accompanying figures, in which like reference numerals designate like elements.

FIG. 1 illustrates an internal construction of a code reader.

FIG. 2 is a perspective view of an illumination unit showing a construction of an illumination portion of FIG. 1.

FIG. 3 is a perspective view showing a configuration of a flexible circuit board shown in FIG. 2.

FIG. 4 is an electric block view of the code reader of FIG. 1.

FIG. 5a is a view showing a configuration of a two dimensional code.

FIG. 5b is a view showing a configuration of a barcode of a code for code reading.

FIG. 6 is a side view of the code reader 1.

### DETAILED DESCRIPTION OF THE PREFERRED EMBODIMENTS

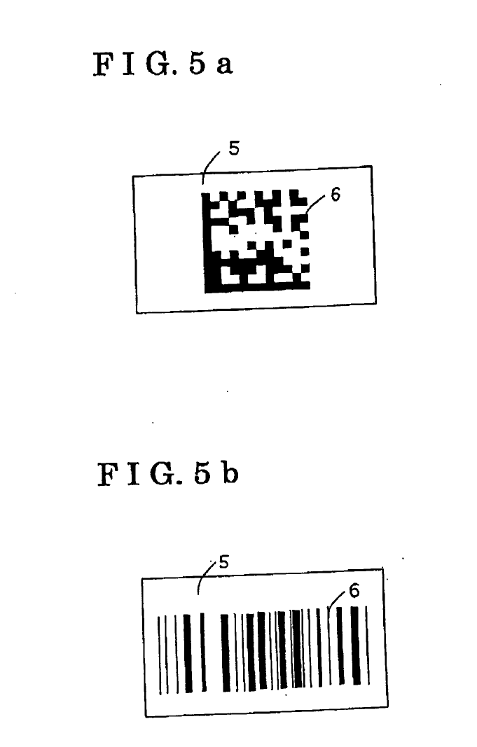

A non-limiting embodiment of the present invention will be explained with reference to the illustrations of the drawing figures. A code reader 1 reads a code 6 provided on an object 5. More particularly, the code reader 1 is capable of reading a matrix type two-dimensional code shown in FIG. 5a and a one-dimensional code such as a barcode shown in FIG. 5b. The code 6 is provided on the object 5, which may be a product for inventory, to control particular products. The code 6 may correspond to a three dimensional code added with color or the gradual light and shade to the two-dimensional code, a multi-dimensional code combined with different dimensional codes, or the like.

On the other hand, the object 5 provided with the code 6 may be made of metal, ceramic, glass, resin, silicon, or the like. Further, the code 6, for example, with the configuration shown in FIG. 5, may be directly provided on the object 5 by surface treatments such as laser marking and etching relative to the material of the object 5. The code 6 may be directly provided on the object 5 via a certain member (e.g., paper or tape provided with the code 6).

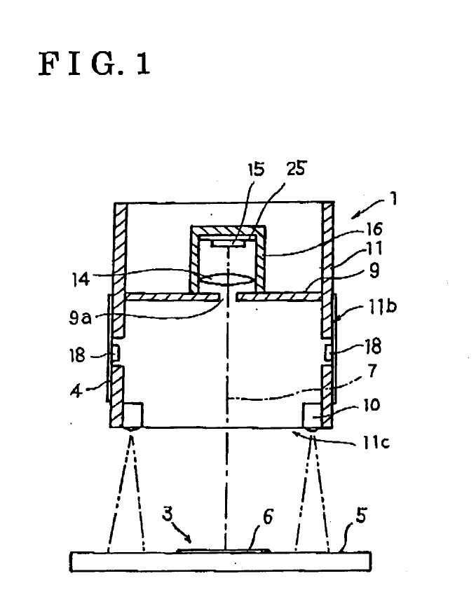

The construction of the code reader 1 will be explained in detail with reference to FIG. 1. The code reader 1 shown in FIG. 1 includes a handheld type housing 11, which may be made of synthetic resin or ABS resin, or the like. Because the code reader is operated by an operator manually gripping the code reader 1, the housing 11 includes a configuration suitable for manual operation (e.g., the configuration of the grip portion may include a configuration matching to the shape of the gripping fingers and hand). The housing 11 includes a hood portion 11b on a tip end, which has an approximately L shape. The hood portion 11b of this embodiment includes a portion extending from an internal bottom surface 9 of the housing 11 to a reading portion 11c.

The hood portion 11b includes an opening on the reading portion side. The illumination light is irradiated through the opening of the hood portion 11b relative to a surface 3 to be read. The rectangular shaped reading portion 11c for receiving the reflective light of the illumination light reflected from the code 6 is formed on a tip end of the hood portion 11b. The hood portion 11b is defined as divided from the housing body by the internal bottom surface 9. A lens group (hereinafter referred as lens) 14 including plural convex lenses and concave lenses is provided at the rear of the internal bottom surface 9. A CCD camera 15 functioning as a two-dimensional sensor is provided at an imaging position of the lens 14 facing the lens 14. The lens 14 is provided in a cylinder member 16 in the housing 11.

The CCD camera 15 for capturing an image and for imaging the image on CCD elements is provided in the center of a circuit board 25, which is fixed on the cylinder member 16. The CCD camera 15 and the lens 14 are positioned to share an identical light axis 7.

A bore 9a having a diaphragm function (incident pupil) for restricting the amount of reflective light is formed in the center of the internal bottom surface 9. The image can be imaged on the CCD element in the CCD camera provided on the back of the bore 9a via the bore 9a. An internal wall of the hood portion 11b and the reading portion 11c of the internal bottom surface 9 is likely to reflect the light when the light contacts the side wall of the housing and the surface of the internal bottom surface 9. A film (i.e., light reflection means) may be formed by surface treatment with less attenuation ratio of the light when the light is reflected, or a film may be formed by coating with white system coating on the internal wall of the hood portion 11b.

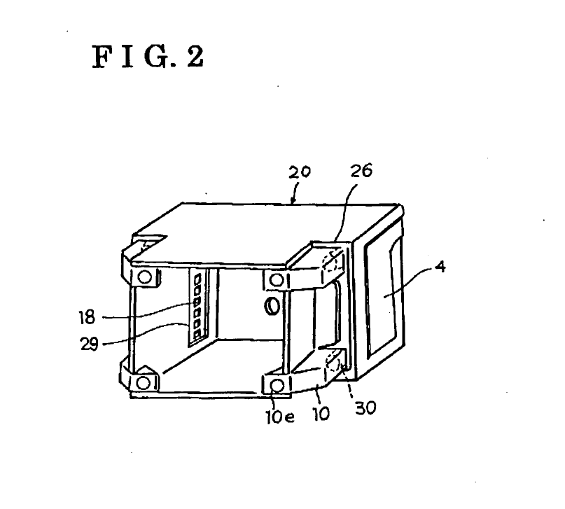

A light source 18 for generating the illumination light through the reading portion 11c is provided on the internal wall of the hood portion 11b. A pair of the light sources 18 illuminates the surface 3 to be read. For example, as shown in FIG. 1, plural pairs of light sources arranged in series may be applied (e.g., as shown in FIG. 2, chip shaped LED generating red light with high brightness arranged in series of six may be applied). The chip shaped LED may be arranged in matrix configuration. A plane surface illuminant for irradiating uniform light may be applied in place of the LED. In addition, by covering the surface of the LED with a diffusion sheet, uniform light (diffusion light) may be produced in the hood portion 11b as a whole.

As shown in FIG. 2, in addition to the light source 18, a marker light source 30 for indicating the operational position of the code reader 1 to the operator with a spot type marker light (spot light) are provided on each corner of the reading portion 11c to illuminate the marker light different from the light source 18 for the illumination from the marker light source 30. The light generated from the marker light source 30 shows the code reading position relative to the code 6 by the positional relationship of, for example in this embodiment, four lights relative to the code 6. In other words, the marker light for indicating the operational position of the code reader 1 may be generated from a light radiation surface 10e provided on the four corners of the reading portion 11c of a light transmission member 10.

As shown in FIG. 2, an illumination unit 20 includes the internal bottom portion 9 through the reading portion 11c of FIG. 1. The illumination unit 20 is detachable relative to the body for operating the housing 11.

The illumination unit 20 includes a convex shape on two opposing aspects, a bottom, and a hollow and is made of resin the same with the housing 11 and further includes an opening of the reading portion 11c. Two opening portions 29 in rectangular configuration are formed opposing each other on left and right side surfaces of the housing of the illumination unit 20 shown in FIG. 2. Four bores, each provided with the marker light source 30, are formed on the side surface 26 of a stepped portion in parallel with the reading portion 11c of the illumination unit 20. Four groove portions are formed on the top and bottom ends of the left and right side walls of the reading portion 11c with narrower opening.

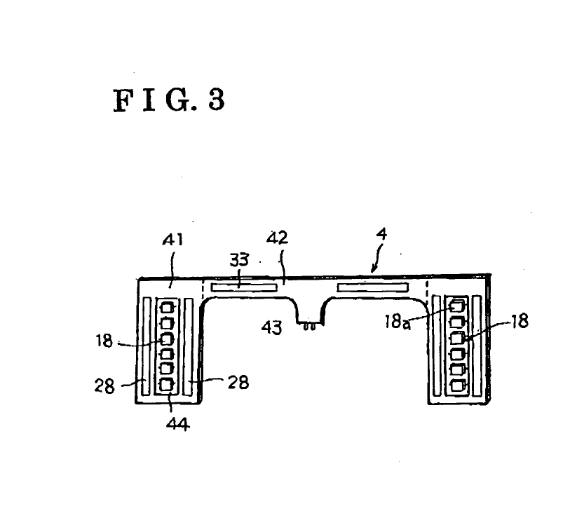

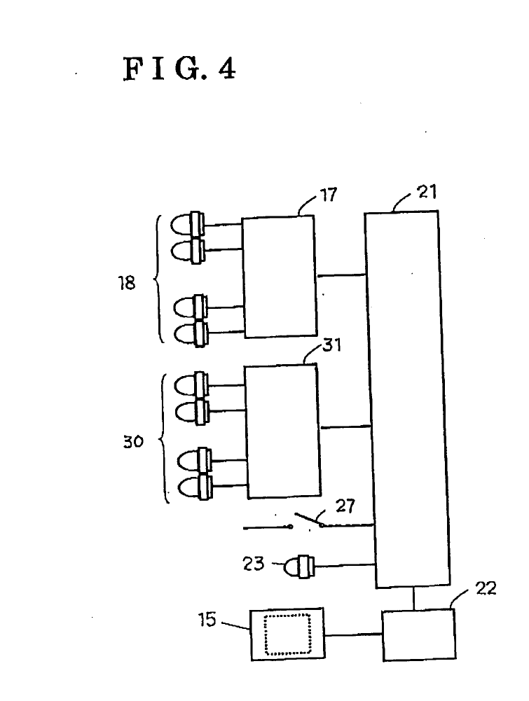

Further, the light sources 18 arranged at a predetermined interval and soldered on the flexible board are arranged on the opening portion 29 of the side surface. More particular positioning of the light source 18 will be explained with reference to FIG. 3.

The light source 18 may be made from a chip shaped LED for generating red light, for example. As shown in FIG. 3, six LEDs 18a are provided in series on both left and right side. A flexible board 4 fixed with the light source 18 is attached in the lateral direction as shown in FIG. 3 relative to the illumination unit 20. A width of a central portion of the flexible board 4 is narrowed so the flexible board 4 does not interfere with the cylinder member 16 provided with the CCD camera 15. Both ends of the flexible board 4 include longitudinally symmetrical long portions extended in the top-bottom direction of the illumination unit 20.

One side of the flexible board 4 will be explained as follows. The flexible board 4 includes a light source boarding portion 41 configured to be long in top-bottom direction, a wiring portion 42 laterally extended from the light source boarding portion 41, and a central terminal portion 43. Using the narrowed wiring portion 42, the configuration of the flexible board 4 can be freely varied in three dimensions.

A circuit pattern supplying the power to an anode and a cathode of the LED forming the light source 18 is formed in the light source boarding portion 41 in parallel as shown in FIG. 3. The wiring pattern of the circuit pattern of the light source boarding portion 41 is changed by ninety degrees so the wiring is through the wiring portion 42 from the light source boarding portion, extended in the lateral direction, and further changed by ninety degrees in the process to be introduced to a terminal portion 43.

The light source boarding portion 41 corresponds to a configuration of the opening portion 29 formed on the side wall of the illumination unit 20 to form an exposed portion 44 exposed in the housing. Each light source 18a is provided with even interval within the range of the exposed portion 44. In case each light source 18a is fixed to the exposed portion 44, the light source 18a is fixed to the circuit pattern of the anode and the cathode with the solder. By providing the diffusion sheet over the six sets of light source 18, the uniform diffusion light can be produced in the illumination unit.

In order to securely assemble the light source boarding portion 41 of the flexible board 4 on the illumination unit 20, an adhesive member 28 (e.g., adhesive tape, adhesive member, adhesive agent such as of epoxy system, or the like) approximately the same length or slightly longer than the longitudinal length of the exposed portion 44 is provided in parallel with the exposed portion 44 on the left and right sides of the exposed portion 44. Further, an adhesive member 33 is provided on the lateral wiring portion 42. By attaching the flexible board 4 on the illumination unit 20 with the adhesive members 28, 33, the light source 18 may be assembled easily.

In this case, it is not required to configure the illumination unit 20 in the complex configuration. The exposed portion 44 is exposed from the opening portion 29 formed on the side surface on left and right and the plural light sources are provided therein such that the flexible board 4 is attached on the illumination unit along the configuration of the housing with the adhesive members 28, 33.

The light transmission member 10 for introducing the marker light to the surface 3 to be read will be explained as follows. The light transmission member 10 may be made of a transparent resin (e.g., acryl resin, polycarbonate resin, or the like) and a central portion thereof includes a recess portion. The light transmission member 10 is provided on left and right sides of the reading portion 11c as shown in FIG. 2. Further, an external peripheral surface of the light transmission member 10 is provided with a reflective membrane (e.g., a metal such as chrome, silver, aluminum, or the like), except the recess portion in which the marker light source 30 is provided and at the rear and the light radiation surface 10e at the front, to shield the light so that the light does not leak outside. This facilitates effective reflection of the light in the light transmission member 10. Thus, the light generated from the marker light source 30 is effectively introduced to the light radiation surface 10e to irradiate the marker light from the light radiation surface 10e at the four corners of the reading portion 11c to the surface 3 to be read. Accordingly, the operator can adjust the operational position of the code reading while observing the marker light so the code 6 corresponds to the central position of the marker position. In this case, the configuration of the light radiation surface 10e may be curved including the lens function.

The configuration of the housing 11 will be explained as follows. An operational lever is provided on the housing 11 at a position so the operator can easily operate the lever. By operating the operational lever, an operational switch 27 is operated together with the operational lever. The operation switch 27 assumes ON state when the operator operates the operational lever and the operation switch 27 assumes OFF state when the operator does not operate the operational lever.

The electrical construction of the code reader 1 will be explained as follows. An operational switch 27 operating together with the operational lever is connected to a CPU 21 controlling the code reader 1, and acts as a triggering switch. A signal of the operational switch 27 triggers a start of the code reading. The CCD camera 15 images the image on the CCD element therein. The CPU 21 is electrically connected to the CCD cameral 15 via a sensor driver 22. The CCD camera sends the image signal imaged on the CCD element to the CPU 21 via the sensor driver 22.

The CPU 21 includes a decode circuit for decoding the information shown on the code 6 input from the image signal. The CPU 21 outputs the restoring data obtained by processing a series of image transactions to the outside. On the other hand, the light source 18 is connected to the CPU 21 via an LED driver circuit 17. The marker light source 30 for illuminating the marker light to the surface 3 to be read is connected to the CPU 21 via the LED driver circuit 31. Further, a light source 23 for confirming that the code reading is turned on when the code reading of the code 6 is successfully achieved is connected to the CPU 21. The foregoing CPU 21, the LED drivers 17, 31, the sensor driver 22, and the CCD camera 15 may be provided on the identical circuit board 25. The flexible board 4 provided with the plural light sources 18 is electrically connected to terminals on the circuit board 25 by soldering. The flexible board 4 and the circuit board 25 may be connected with a connector.

The code 6 to be read by the code reader 1 will be explained as follows. As shown in FIG. 3, the code 6 is provided on an object 5 (e.g., product). For example, inventory control may be achieved using the code reader 1 by reading the code 6 provided on each product.

The code 6 shown in FIG. 3 is directly provided relative to the metal surface by laser processing or the like. For example, a matrix code with 12 by 12 may be applied. The variation of the code 6 is not limited to the foregoing construction, and other codes such as a QR code may be applied.

The operation of the code reader 1 will be explained as follows. Operating the operational lever activates the code reader 1. In other words, the operation of the code reader 1 is initiated by operating the operational lever to turn the operational switch 27 ON as the trigger. Triggered by the initiation of the operation, the CPU 21 commands the LED driver 17 to illuminate the light source 17. When the command is sent to the light source 18, the light source 18 is turned on. Thus, the surface 3 to be read provided on the code 6 is illuminated by the light generated from the light source 18. The light generated from a pair of the light sources 18 attached on the internal wall of the hood portion 11b enables the illumination light to be introduced from the reading portion 11c to the surface 3 to be read.

The marker light is irradiated to the surface 3 to be read alternately with the illumination light from the light source 18. The CPU 21 commands the LED driver 31 for the marker to drive the marker light source 30 for generating the light. Receiving the command from the CPU 21, the illumination light for the marker is generated from the marker light source 30. The light generated from the marker light source 30 is transmitted to a front at the light radiation surface 10e where the reading portion 11c is positioned and the marker light is generated from light radiation surfaces 10e to the surface 3 to be read. Thus, because the operator can visually recognize the reading position relative to the code 6 by the marker lights, the operator can easily adjust the operational position for code reading.

When the code reader is positioned at a position for reading the code, the illumination light generated from the light source 18 contacts the code 6 to be reflected. The light reflective condition of the code 6 differs, depending on the positional variation of the bright and dark cells, because the individual code 6 is formed combining plural bright and dark cells in a matrix configuration. Thus, the reflective light reflected after contacting the bright and dark cell of the code 6 varies depending on the darkness and brightness condition of the code. The reflective light including the code information is transmitted to the reading portion 11c. Thereafter, the reflective light reflected from the code 6 enters the bore 9a formed at the center of an internal bottom surface 9 for reducing the light amount, and is imaged on the CCD element of the CCD camera 15 via the lens 14 to read the code. Thus, the image (i.e., the image showing the unique information) based on the configuration of the code 6 of the surface 3 to be read is imaged on the CCD element of the CCD camera 15 via the lens 14. The image imaged on the CCD camera 15 is successively introduced to the CPU 21 via the sensor driver 22 to be sent to the decode circuit in the CPU 21. The decode circuit converts the image into binary form, identifies a dot position pattern, decodes the information shown on the code 6, and recognizes the code identifying the information regarding the object 5.

Thereafter, the CPU 21 judges whether the decoding is completed. In case the decoding has not been completed, the transaction is repeated from the light generation by the light source until the decoding is completed. In case the decoding is completed, the light source 23 for confirmation provided on the back surface of the housing 11 may be turned on, or an aural signal may be sounded to inform the operator. Further, the decoded information may be sent to an external device connected to the code reader 1 for communication to analyze the contents or type of the code 6.

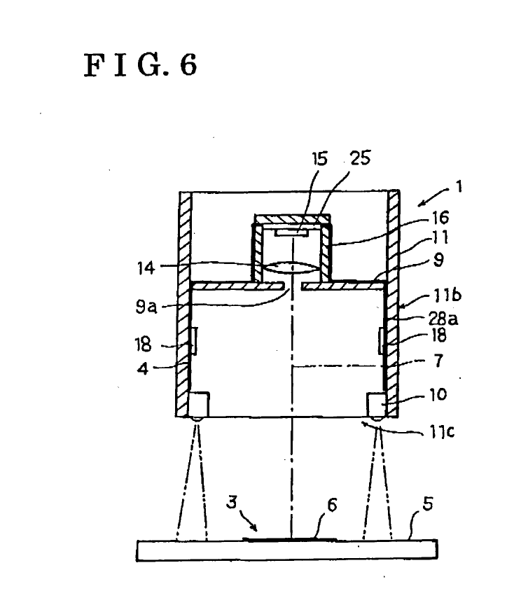

Although the plural light sources 18 may be provided on one side of the flexible board 4 and the adhesive member 28 may be provided on both sides of the light source in the embodiment, the arrangement is not limited to this construction and as shown in FIG. 6, an adhesive member 28a may be provided on an opposite surface of the flexible board 4, different from the surface where the light source 18 is provided.

Although the light source 18 is provided on the flexible board 4 in the embodiment, in place of the light source 18, the marker light source 30 may be provided on the flexible board 4. Both the light source 18 and the marker light source 30 may be provided on one flexible board 4.

Although the flexible board 4 is attached on the housing 11 via the adhesive members 28, 33 in the embodiment, the position and the number of the adhesive members 28, 33 are not limited to the construction in the embodiment. Further, the flexible board 4 may be permanently attached via the adhesive agent in case the flexible board 4 is not to be exchanged after the attachment.

According to one embodiment of the present invention, the attachment of the flexible board to the housing is easy, even if the light sources are opposingly arranged as in the construction for attaching the plural light source on the flexible board. Thus, the plural light sources may be attached with a simple method and lower cost.

In this case, by providing the opening portion between the light restriction means and the reading portion on the side wall of the housing and the plural light sources are provided on the flexible board provided on the opening portion, the plural light source can be provided at the opening position without complex wiring construction only by forming the opening position between the reading portion and the light restriction means on the side wall of the housing.

Because the light sources are arranged in series, the adhesive means is provided on both sides of the light sources to be fixed on the housing, the plural light sources provided on the flexible board via the adhesive means may be securely fixed to the opening portion.

The principles, preferred embodiment and mode of operation of the present invention have been described in the foregoing specification. However, the invention that is to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents, which fall within the spirit and scope of the present invention as defined in the claims, be embraced thereby.

1. A code reader comprising:
a housing;
a reading portion provided at the housing for reading a code provided at an object;
image capturing means provided at the housing for capturing an image of the code;
light generating means including a light source provided at the housing for irradiating an illumination light to the code;
light restriction means for restricting an amount of reflected illumination light, reflected from the code, that enters the image capturing means; and
a flexible board provided at the housing, on which the light source is positioned.

2. The code reader according to claim 1, wherein the housing includes an opening portion between the light restriction means and the reading portion, and the flexible board is positioned at an internal wall of the housing that faces the opening portion.

3. The code reader according to claim 1, further comprising an adhesive provided at a side of the light source, the adhesive fixing the flexible board to the housing.

4. The code reader according to claim 1, wherein the light source includes plural light sources arranged in series.

5. The code reader according to claim 4, further comprising adhesives provided at both sides of the plural light sources, the adhesives fixing the flexible board to the housing.

6. The code reader according to claim 4, wherein the housing includes an opening portion between the light restriction means and the reading portion and the flexible board provided with the plural light sources is provided at an internal wall of the housing that faces the opening portion.

7. A code reader comprising:
a housing;
a reading portion provided at the housing for reading a code provided at an object;
a CCD camera provided at the housing for capturing an image of the code;
a light source provided at the housing configured to irradiate an illumination light to the code;
a light diaphragm configured to restrict an amount of reflected illumination light, reflected from the code, that enters the CCD camera; and
a flexible board provided at the housing, on which the light source is positioned.

8. The code reader according to claim 7, wherein the housing includes an opening portion between the light diaphragm and the reading portion, and the flexible board is positioned at an internal wall of the housing that faces the opening portion.

9. The code reader according to claim 7, further comprising an adhesive provided at a side of the light source, the adhesive fixing the flexible board to the housing.

10. The code reader according to claim 7, wherein the light source includes plural light sources arranged in series.

11. The code reader according to claim 10, further comprising adhesives provided at both sides of the plural light sources, the adhesives fixing the flexible board to the housing.

12. The code reader according to claim 10, wherein the housing includes an opening portion between the diaphragm and the reading portion and the flexible board provided with the plural light sources is provided at an internal wall of the housing that faces the opening portion.
